(19) United States
(12) Patent Application Publication
(10) Pub. No.: US 2008/0037743 A1
(43) Pub. Date: Feb. 14, 2008

(54) Devices, Methods and Computer Program Products for Delaying Connection of an Incoming Telephone Call to Allow a Receiving Party Additional Time to Accept the Incoming Telephone Call

(75) Inventor: Michael L. Bishop, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/428,688

(22) Filed: Jul. 5, 2006

(51) Int. Cl. H04M 3/42

(52) U.S. Cl. 379/201.01

(57) ABSTRACT

A connection of an incoming call to a receiving party is delayed in response to receipt of a delay instruction from the receiving party, to allow the receiving party additional time to accept the incoming telephone call. The delay may be provided by delaying transfer of the incoming call to the receiving party's voice mail, by extending a ring cycle and/or by presenting a hold message.

### FIELD OF THE INVENTION

This invention relates to communication devices (apparatus), methods, and/or computer program products and more particularly to telecommunications devices, methods and/or computer program products.

### BACKGROUND OF THE INVENTION

The telephone has become ubiquitous in modern society. As used herein, a telephone denotes any wired and/or wireless device that facilitates voice communications between parties, and can include wireline telephones such as plain old telephone system (POTS) or voice over Internet protocol (VoIP) wireline telephones and/or wireless telephones such as cellular and/or satellite telephones, whether stand-alone devices or integrated with other devices such as personal computers, personal digital assistants (PDA), wireless email devices, pagers, web browsers, organizers, calendars, positioning systems and/or other devices, and which may include video and/or data communication capabilities in addition to voice communication capabilities.

As the number of telephone calls made by an individual during the course of a day for personal or business reasons continues to increase, and the number of devices from which telephone calls may be made or received continues to increase, it has become increasingly difficult to efficiently use the telephone. Features such as caller ID and voice mail have been developed to allow a party to more efficiently use the telephone.

### SUMMARY OF THE INVENTION

Embodiments of the present invention provide devices, methods and/or computer program products for facilitating a telephone call between a first party and a second party by presenting to the first party, previously generated notes related to subject matter of a future telephone call with the second party, in response to initiation of an outgoing telephone call to the second party by the first party and/or receipt of an incoming telephone call from the second party by the first party. A reminder is thereby provided to remind the first party of the subject matter of the telephone call between the first party and the second party. Stated differently, the pregenerated notes that are presented to the first party can jog the memory of the first party as to the subject matter of the telephone call with the second party.

In some embodiments, prior to presenting the notes, input of the notes may be accepted along with an identification of the second party. The notes and identification that were accepted are then stored for later presentation in response to initiation of an outgoing telephone call to the second party by the first party and/or receipt of an incoming telephone call from the second party by the first party. The notes may be generated by the first party, by the second party and/or by a third party. Moreover, after the notes are presented, they may be selectively deleted, saved to provide a recurring reminder and/or logged. The notes may be presented by displaying the notes on a display and/or by audibly presenting the notes as speech. In some embodiments, the notes may be automatically presented or may be presented in response to an indication by the first party to accept presentation of the notes.

According to yet other embodiments of the present invention, the connection of the incoming telephone call from the second party to the first party or the connection of the outgoing call by the first party to the second party, may be delayed, so as to allow the first party to review the notes before beginning the incoming/outgoing telephone call. In some embodiments, the incoming telephone call may be delayed by extending a ring cycle for the incoming telephone call beyond the ring cycle for an incoming telephone call that does not include notes associated therewith. In other embodiments, the connection of the incoming telephone call may be delayed by presenting a “hold” message to the second party while the connection of the incoming call is being delayed.

Yet other embodiments allow an incoming telephone call to be delayed independent of the presenting of notes related to the telephone call. In particular, in some embodiments, connection of an incoming telephone call to a receiving party may be delayed in response to receipt of a delay instruction from the receiving party, so as to provide the receiving party additional time to accept the incoming telephone call. For example, the receiving party may be driving or otherwise not immediately available to accept the phone call, but may wish to delay the connection slightly to allow the receiving party a little additional time to accept the incoming telephone call. In some embodiments, transfer of the incoming call to the receiving party's voice mail may be delayed in response to receipt of the delay instruction from the receiving party. The delay may be embodied by extending the ring cycle and/or by presenting a “hold” message as was described above.

It will be understood that embodiments of the invention have been described above in connection with a telephone call. However, other embodiments of the present invention may be used with other “real time” communications sessions other than telephone calls, such as instant messaging sessions and/or text messaging sessions, to allow previously generated notes to be provided to a party for use in connection with an instant message and/or text message that is received and/or will be sent.

It also will be understood that the present invention may be embodied as a computer program product that executes on a telephone, computer and/or communications network, by hardware including a telephone, that is configured to execute the computer readable program code and/or by methods of facilitating telephone calls. Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of devices (apparatus), methods and/or computer program products for facilitating telephone calls between various parties according to various embodiments of the present invention.

FIGS. 2-4 are flowcharts of operations that may be performed to provide reminders according to various embodiments of the present invention.

FIG. 5 is a flowchart of operations that may be performed to generate reminders according to various embodiments of the present invention.

FIG. 6 is a flowchart of operations that may be provided to delay an incoming call according to various embodiments of the present invention.

FIG. 7 is a flowchart of operations that may be performed to place a call with a reminder according to various embodiments of the invention.

FIG. 8 is a flowchart of operations that may be performed to receive a call with a reminder according to various embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first telephone or party could be termed a second telephone or party, and, similarly, a second telephone or party could be termed a first telephone or party without departing from the teachings of the disclosure.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Some embodiments of the present invention may arise from recognition that it may be difficult for a given party to remember the various subject matters that the given party wishes to or needs to discuss with one or more other parties when they speak over the telephone. Some embodiments of the present invention allow a first party, or any other party, to generate and store reminders that are associated with an identification of a second party, so that when the first party initiates a telephone call to, or receives an incoming telephone call from, the second party, the notes may be presented to the first party as a reminder of the desired subject matter of the telephone call between the first and second parties. The notes may be, for example, a list of topics to be discussed, a point of information to be discussed or other information associated with the phone call with the second party, such as the names of the second party's children. Accordingly, notwithstanding the many telephone calls that are made during the day, a telephone caller can be reminded of the desired topics of conversation when the phone call is actually made or received.

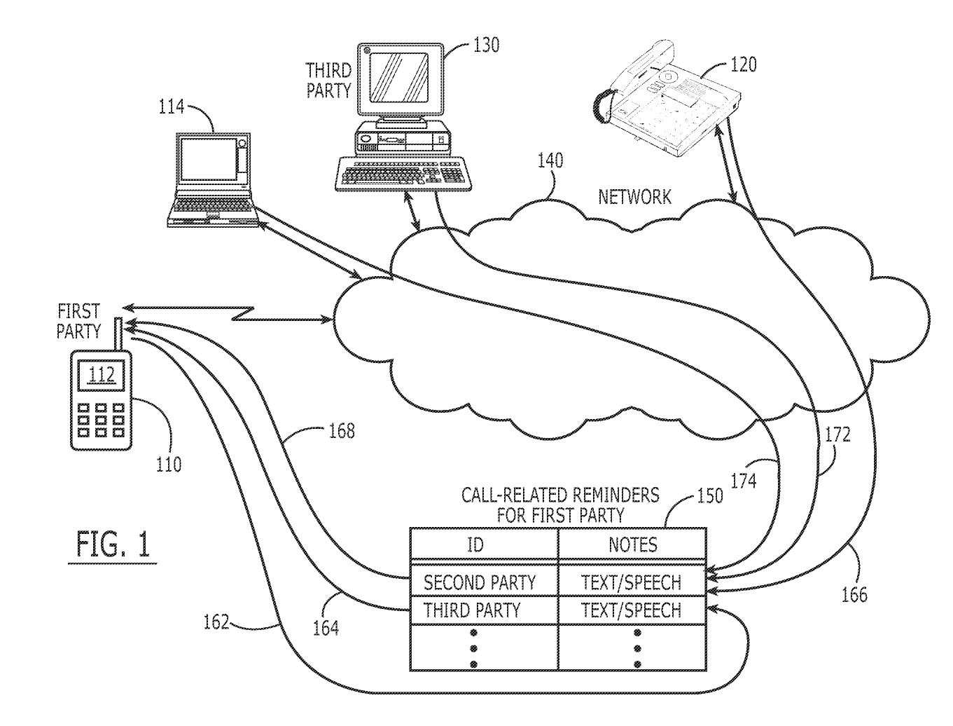

FIG. 1 is a block diagram of apparatus (systems/devices), methods and/or computer program products for facilitating a telephone call between a first party and a second party according to some embodiments of the present invention. As shown in FIG. 1, a first party uses a first telephone 110 (also referred to as a first party telephone), a second party uses a second telephone 120 (also referred to as a second party telephone) and a third party uses a third telephone 130 (also referred to as a third party telephone) that are interconnected by a telecommunications network 140. It will be understood by those having skill in the art that although the first telephone 110 is illustrated as a cellular telephone, the second telephone 120 is illustrated as a POTS telephone and the third telephone 130 is illustrated as a VoIP telephone using a personal computer, any and all types of telephones may be used by any of the first, second or third parties. The network may include a conventional POTS network, a wireless network, an Internet protocol network and/or any other type of network that may be used to interconnect telephones. The network may provide other functionality besides telecommunications. It will also be understood that, typically, many more than three parties are interconnected by the network 140.

Still referring to FIG. 1, a database 150 of call-related reminders for the first party may be provided. In some embodiments, the database 150 may be embodied in the first party telephone 110. However, in other embodiments, the database 150 may be embodied in a component of the network 140 and/or in a device that is attached to the network 140. In these network-related embodiments, a centralized database of call-related reminders for multiple parties may be provided.

Still referring to FIG. 1, according to some embodiments of the present invention, previously generated notes from the database 150 that relate to a future telephone call with the second party may be presented to the first party. The notes related to the second party may be presented to the first party, for example by displaying on the display 112 of the first party telephone 110, in response to initiation of an outgoing telephone call to the second party by the first party and/or in response to receipt of an incoming telephone call from the second party by the first party, so as to remind the first party as to the subject matter of the telephone call between the first party and the second party.

More specifically, the database 150 for the first party may include a collection of notes that provide reminders to the first party. The notes may be presented to the first party when a call with a given other party is either initiated or received. The database 150 may include an identification (ID) of the other party and the notes that were generated to provide the reminders. The identification may use a telephone number associated with the other party, the name of the other party, and/or any other conventional technique for identifying a calling or called party for telephone communications. The notes may be text that may be entered from a keyboard of a given telephone or other device and/or may be speech that is input to a telephone or other given device.

According to some embodiments of the invention, any party may provide reminder notes for itself and/or for any other party. Some of these embodiments are illustrated by the directional arrows in FIG. 1. In FIG. 1 it is assumed that reminders are provided for the first party. Insertion of a reminder note is indicated by an arrow pointing to the right side of the call-related reminder database 150 and extraction of a reminder is illustrated by an outgoing arrow from the left side of the database 150.

Specifically, in some embodiments, a given party may provide reminders to itself as to phone calls that are later made to or received from another given party. Thus, arrow 162 illustrates generation of a reminder note by the first party relative to a future outgoing call to or incoming call from the third party. Upon placing an outgoing call to the third party or upon receiving a call from the third party, the appropriate reminder may be extracted, as shown by arrow 164, and presented to the first party telephone 110 as a displayed message on display 112 and/or as a voice message on the speaker or headset of the first party telephone 110. In a simplified example, assume the first party is an employee and the third party is the employee's manager. Arrow 162 can illustrate the employee generating a reminder to himself/herself to schedule a meeting with the manager the next time the employee speaks with the manager. Arrow 164 can represent presentation of this message at the employee's phone the next time the employee calls the manager or the next time the manager calls the employee.

In another example, arrow 166 illustrates that the second party 120 may insert a reminder into the database 150 for the first party. Arrow 168 illustrates that when the first party calls the second party, or vice versa, the message that was inserted by the second party may be presented to the first party. Thus, continuing with the above simplified example, if the second party is the employee's manager, the employee's manager can place a reminder message which states “set up a meeting with me” and the reminder may be provided to the employee the next time the employee calls the manager or the manager calls the employee.

Arrow 172 illustrates another scenario wherein a third party stores a message in the reminder database 150 for the first party that relates to the second party. For example, the third party may wish to remind the employee to set up a meeting with the employee's manager. Then, as shown by arrow 168, the next time the employee calls the manager or the manager calls the employee, the message that was inserted by the third party may be presented. Finally, it will be understood that a given reminder message may be directed to more than one party to provide, for example, “workgroup” reminders.

It will also be understood that the messages for the first party that are inserted by the first party need not be inserted from the first party telephone 110 itself. Rather, a second device 114 may be used by the first party to insert a reminder message as shown by arrow 174. Similarly, any other party may insert a reminder using any device, which need not be the other party's telephone. Finally, a reminder may be directed to a given party, independent of the telephone the party is using. For example, a message may be sent to both a cell phone and a wireline phone belonging to a given party.

In any of the above embodiments, a message may be inserted into the database 150 by using a telephone to insert a voice message, a text message, an email message and/or any other alphanumeric message as a note in the database 150. Moreover, any other non-telephone device such as the device 114 may also be used to insert a voice message, a text message, an email message, and/or any other alphanumeric message into the database 150. In some embodiments, the database 150 may be maintained at a web server (such as a telecommunications provider web server and/or a dedicated reminder web server) and may be accessed by a web browser via email and/or by filling out a form on a web page. In stand-alone embodiments, the database 150 may be included within the first party telephone 110 and notes may be inserted by the first party using the keyboard and/or microphone of the first party telephone 110 and may also be inserted by other parties by sending an email, page, text message, voice mail message and/or other message to the first party telephone 110. The message may contain an identification of the first party telephone (e.g., a telephone number) in a subject or header field, and the notes in the body of the message.

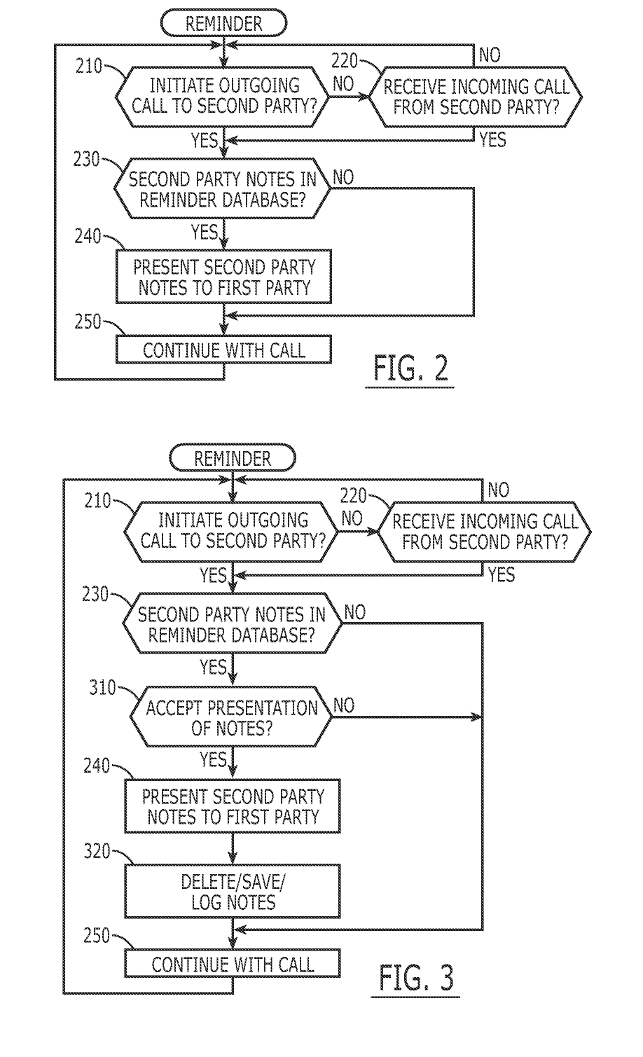

FIG. 2 is a flowchart of operations that may be performed to provide reminders as to the subject matter of a telephone call according to some embodiments of the present invention. These operations may be performed by a telephone 110, 120, 130 and/or by another device (such as device 114) that is connected to the network 140, in conjunction with the reminder database 150. In particular, as shown in FIG. 2 at Block 210, in response to initiation of an outgoing telephone call to the second party by the first party and/or as shown at Block 220, in response to the receipt of an incoming telephone call from the second party by the first party, a determination may be made at Block 230 as to whether previously generated notes related to a future telephone call with the second party are present in a reminder database, such as the reminder database 150 of FIG. 1. As was already described, the second party notes may be generated by the first party, by the second party and/or by another party. In some embodiments, the determination of Block 230 may determine whether there is a match for the second party ID in the reminder database 150 for the first party. If there is a match, then the second party notes may be presented to the first party at Block 240. As was described above, the second party notes may be presented to the first party by displaying an alphanumeric message and/or by generating a speech message at the first party telephone 110. In other embodiments, the message may be sent to a device other than the first party telephone 110, such as a pager or computer that is used by the first party. Thus, in some embodiments, the notes regarding the call may be delivered to the first party's email in-box on the first party's computer. Thereafter, operations may be performed to continue with the call at Block 250 by continuing to initiate the outgoing call and/or to receive the incoming call.

FIG. 3 is a flowchart of operations that may be performed to provide reminders according to yet other embodiments of the present invention. Specifically in FIG. 3, after a determination may be made at Block 230 that there are second party notes available, a determination may be made at Block 310 as to whether the first party has provided an indication that the first party wishes to accept presentation of notes. The indication may be presented at Block 310 by pre-enabling a reminder feature at the first party telephone 110, in response to a prompt that is displayed immediately before presentation of the notes, by activation of a predetermined key on the telephone 110 and/or by using other conventional techniques. If the first party has not indicated that it wishes to accept presentation of notes at Block 310, the presentation of notes is bypassed. It will also be understood that the operations of Blocks 230 and 310 may be performed in the reverse order from that shown in FIG. 3.

FIG. 3 also illustrates that after the second party notes are presented at Block 240, the notes may be processed at Block 320. In operations of Block 320, the notes may be deleted as no longer needed, saved in order to provide a recurring reminder and/or logged for archival purposes. A recurring reminder may be provided because the first party wishes to have the reminder presented every time he calls the third party. Thus, for example, in the employee/manager scenario presented above, the notes may be the names of the manager's children and the employee may wish to be reminded of the manager's children's names every time the employee calls the manager or receives a call from the manager, to allow pleasantries to be exchanged at the beginning of the telephone call. It will also be understood that operations of Block 320 may be performed at other points in the flowchart of FIG. 3.

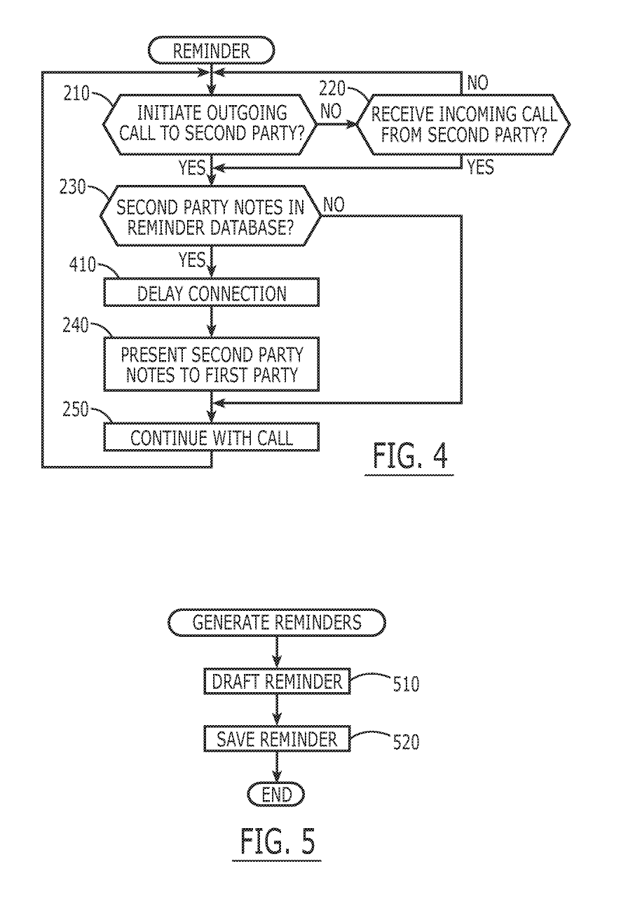

FIG. 4 is a flowchart of operations that may be performed to generate reminders according to still other embodiments of the present invention. In these embodiments, after performing the operations of Blocks 210 and 220, and determining that there are second party notes available at Block 230, the connection of an incoming or outgoing telephone call from or to the second party may be delayed so as to allow the first party to review the notes before beginning the incoming/outgoing telephone call.

Many embodiments of the operations for delaying the connection, corresponding to Block 410 of FIG. 4, may be provided according to various embodiments of the present invention. In some embodiments, the connection of an incoming telephone call from the second party to the first party may be delayed by extending a ring cycle for the incoming telephone call beyond the ring cycle for an incoming telephone call that does not include notes associated therewith. For example, the first party telephone 110 may be configured to place an incoming caller in voice mail after six unanswered rings. However, according to some embodiments of the present invention, when notes are presented to the first party, the first party telephone may be configured to place the incoming caller in voice mail after nine rings, thereby allowing three additional rings for the first party to read the notes and then accept the call. In other embodiments, the connection may be delayed by presenting a “hold” message to the second party while the connection of the incoming call is being delayed. Thus, a message of “please wait” may be presented once or repeatedly to allow the connection to the incoming call to be delayed. Other embodiments may provide a distinctive ring tone, background music and/or other conventional delay tones to allow the first party an extended time to review the notes before connecting to the call.

In other embodiments, connection to an outgoing telephone call by the first party to the second party may be delayed. This delay may be provided, in some embodiments, by not beginning the outgoing telephone call until a “send” key or other indication is provided by the first party on a cellular telephone. In a wireline telephone, the almost instantaneous connection that is provided to a second party may be delayed for a predetermined time, such as for 10 or 15 seconds, to allow the first party to review the notes. Other embodiments may provide a distinctive ring tone, background music and/or other conventional delay tones, to allow the first party an extended time to review the notes before connecting to the outgoing call.

FIG. 5 is a flowchart of operations that may be performed to generate reminders that may be used, for example, to populate the reminder database 150 for later use when a telephone call is initiated and/or received. In particular, referring to FIG. 5, at Block 510 a reminder may be drafted, for example, by typing an email, typing a text message and/or speaking a voice message. As was described above, a reminder for a first party may be drafted by the first party itself at the first party telephone 110 and/or at another user terminal that is accessible by the first party, by a second party for calls between the second party and first party and/or by a third party for calls between the first party and the second party.

Continuing with the description of FIG. 5, at Block 520, the reminder may be saved. In some embodiments where a separate database is provided for each party, the reminder may be saved in the database for the first party and indexed based upon the ID of the second party. An identification of the party that generated the message also may be saved. Alternatively, in other embodiments where a centralized database is used to store reminders for many parties, the reminders may be indexed by the intended recipient of the reminder and by the other party to which the reminder applies. The identity of the party who generated the reminder may also be stored.

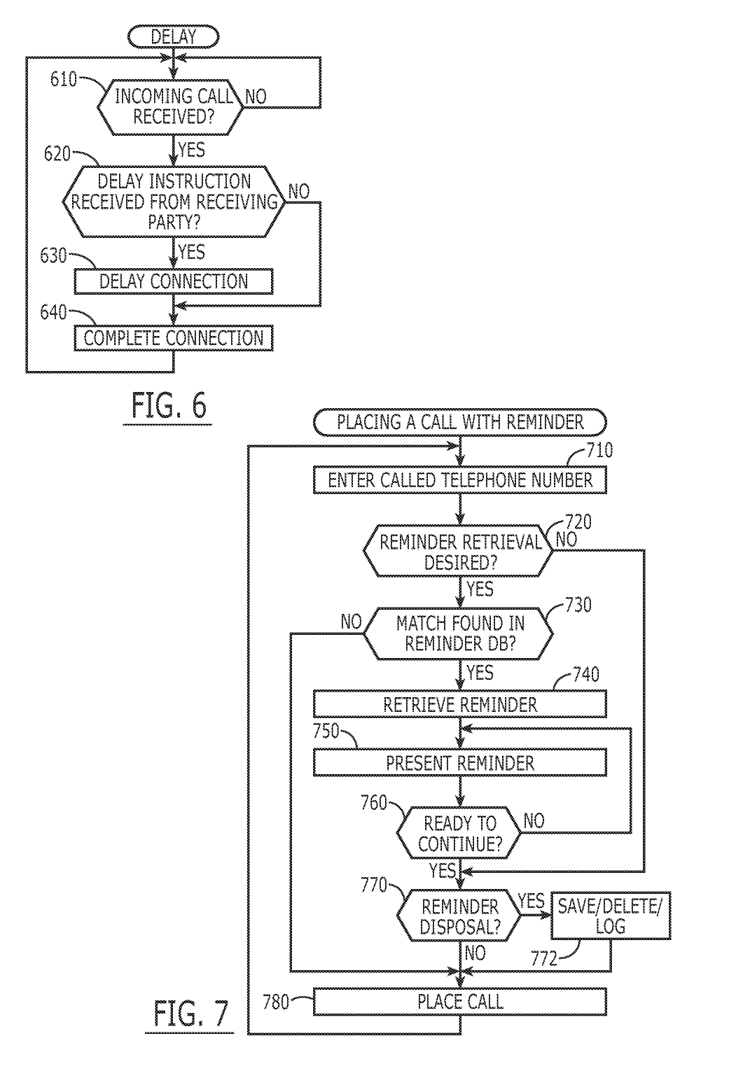

FIG. 6 is a flowchart of operations that may be performed to provide a delay according to other embodiments of the present invention. In particular, a delay was provided at Block 410 of FIG. 4 so as to allow the first party to review the notes before beginning the incoming/outgoing telephone call. Embodiments of FIG. 6 may arise from recognition that a delay may be provided for other purposes. For example, the user of a cell phone may be completing another activity, such as a purchase of goods, and may wish to accept an incoming phone call after a slight delay rather than having the incoming call go to voice mail and necessitating a call-back. In another scenario, the receiving (called) party may be driving in a treacherous situation and may wish to delay receipt of the call for a short time period when it is safer to accept the call, without sending the incoming call to voice mail. Other scenarios may be envisioned where it is desired to delay the call slightly rather than have the incoming call be sent to voice mail.

Referring now to FIG. 6, at Block 610, upon receipt of an incoming call, a determination may be made as to whether the receiving (called) party wishes to delay connection of the incoming call, at Block 620. A delay instruction may be provided, for example, by pressing a predetermined key, such as the # key, on the receiving party's telephone. Alternatively, a prompt may be presented on the telephone's display as to whether the user wishes to delay receipt of the call and the user can respond to the prompt by a voice and/or keystroke response. If the delay instruction is received from the receiving (called) party at Block 620, then the connection may be delayed at Block 630, for example, using any of the techniques that were described in connection with Block 410 and/or other conventional techniques for placing a telephone call on hold.

Finally, at Block 640 at the end of the delay period, the connection may be completed. In some embodiments, the connection may be completed by automatically connecting the called party and the calling party. In other embodiments, the called party is not connected to the calling party unless a key such as the “send” key on a cell phone is depressed or a wireline phone is picked up. In still other embodiments, if the “send” key is not depressed or the wireline phone is not picked up, then after the delay, the caller may be sent to voice mail. Accordingly, in some embodiments, the connection of an incoming call to a receiving party may be delayed by delaying transfer of the incoming call to the receiving party's voice mail in response to receipt of the delay instruction from the receiving party.

FIG. 7 is a flowchart of operations in which a call is placed, i.e. an outgoing call is initiated, according to various embodiments of the present invention. As shown in FIG. 7, upon entering a called telephone number by a calling party at Block 710, it may be determined at Block 720 if reminder retrieval is desired. This determination may be made by presetting a flag, by providing a default for reminder retrieval and/or by providing a prompt to the caller in response to entry of the called telephone number. In other embodiments, reminders may always be presented if they are present.

If reminder retrieval is desired, then, at Block 730, a determination may be made as to whether a match is found in the reminder database by identifying any notes for the calling telephone number that are associated with the called telephone number. If a match is not found, then the call may be placed. However, if a match is found, then the reminder may be retrieved at Block 740 and presented at Block 750 as text and/or speech.

Continuing with the description of FIG. 7, in some embodiments, after the reminder is presented, operations may automatically continue. However, in other embodiments, as shown at Block 760, operations may not continue until the user indicates that the user is ready to continue. For example, upon presentation of the reminder, the user may wish to gather their thoughts before continuing to place the call. The user may indicate readiness to continue by entering a voice and/or keypad response. Optionally, at Block 770, a reminder disposal prompt may be provided so that the user can identify whether the notes should be saved, deleted and/or logged, at Block 772. Alternatively, defaults may be set, for all notes or on a per-note basis, and a specific prompt for disposal need not be provided. At Block 780, the call is then placed.

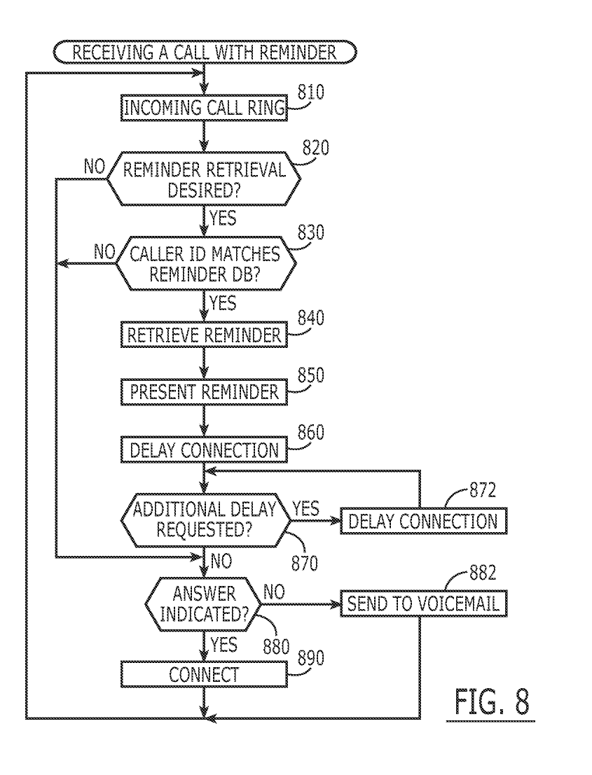

FIG. 8 is a flowchart of operations that may be performed to receive an incoming call according to various embodiments of the present invention. Referring to FIG. 8, at Block 810, an incoming call ring is received and, at Block 820, a determination may be made as to whether reminder retrieval is desired. These operations may be similar to those that are performed in connection with Block 720 and will not be described again. It will also be understood that, in some embodiments of Block 820, by requiring the receiving party to indicate that a reminder is desired, the calling party need not be placed in a delay mode when the receiving party is not even present at the receiving party telephone.

Continuing with the description of FIG. 8, if “yes” at Block 820, then at Block 830, a determination may be made as to whether a match for the caller ID is found in the reminder database, which may be similar to the operations that were performed at Block 730. If “yes,” then the reminder is retrieved at Block 840, which may be similar to the operations that were described for Block 740. At Block 850, a reminder is presented, which may be similar to the operations of Block 750.

Continuing with the description of FIG. 8, at Block 860, the connection may be delayed to allow the receiving party additional time to review the reminder before beginning the incoming telephone call. The delay may be provided as was already described in connection with Block 630. Moreover, the delay of Block 860 may be provided automatically or in response to an instruction as was described at Block 620 in FIG. 6. At Block 870, a determination may be made as to whether additional delay is desired. If additional delay is requested, then an additional delay may be provided at Block 872. The time of the additional delay (Block 872) may be the same as or different from the time of the initial delay (Block 860). When additional delay is no longer requested at Block 870, then a determination may be made at Block 880 as to whether the receiving party wishes to answer the call, for example, by pressing the “enter” or “send” key of a cellular phone or by taking a wireline phone off-hook. If “answer” is not indicated, then the call may be sent to voice mail at Block 882. On the other hand, if an answer is indicated, then the call may be connected at Block 890. Prior to or after connecting the call at Block 890, operations for reminder disposal that were described in connection with Blocks 770 and 772 of FIG. 7 also may be provided.

Accordingly, some embodiments of the invention may present previously generated notes to a first party that relate to a future telephone call with a second party in response to initiation of an outgoing telephone call to the second party by the first party and/or receipt of an incoming telephone call from the second party by the first party. A reminder is thereby provided to the first party as to the subject matter of the telephone call between the first party and the second party. The reminder may be generated by any party and may be presented as speech and/or text. A delay may be implemented in order to allow the first party to review the notes. Moreover, a delay of a connection of an incoming call may be provided independent of the presence of a reminder to allow the receiving party to delay acceptance of a telephone call for a short period. Finally, it will be understood that the various embodiments described herein in connection with FIGS. 1-8 may be used in many combinations and subcombinations.

It will be understood that embodiments of the invention have been described above in connection with a telephone call. However, other embodiments of the present invention may be used with other “real time” communications sessions other than telephone calls, such as instant messaging sessions and/or text messaging sessions, to allow previously generated notes to be provided to a party for use in connection with an instant message and/or text message that is received and/or will be sent.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A computer program product for facilitating a telephone call, the computer program product comprising a computer usable storage medium having computer-readable program code embodied in the medium, the computer-readable program code comprising:
computer-readable program code that is configured to delay connection of an incoming telephone call to a receiving party in response to receipt of a delay instruction from the receiving party, so as to provide the receiving party additional time to accept the incoming telephone call.

2. A computer program product according to claim 1 wherein the computer-readable program code is further configured to delay connection of an incoming telephone call to a receiving party by delaying transfer of the incoming call to the receiving party's voice mail, in response to receipt of the delay instruction from the receiving party.

3. A computer program product according to claim 1 wherein the computer-readable program code is further configured to delay connection of the incoming telephone call by extending a ring cycle for the incoming telephone call beyond the ring cycle for an incoming telephone call for which the delay instruction is not received.

4. A computer program product according to claim 1 wherein the computer-readable program code is further configured to delay connection of the incoming telephone call by presenting a hold message while the connection of the incoming call is being delayed.

5. A computer program product according to claim 1 wherein the delay instruction comprises activation of a given key on the receiving party's telephone.

6. A computer program product according to claim 1 wherein the computer-readable program code is further configured to present to the receiving party, previously generated notes related to the incoming telephone call, in response to receipt of the delay instruction from the receiving party.

7. A computer program product according to claim 6 wherein the computer-readable program code is further configured to present notes that were previously generated by the receiving party and/or by another party.

8. A computer program product according to claim 6 wherein the computer-readable program code is further configured to selectively delete the notes after they are presented, to save the notes to provide a recurring reminder and/or to log the notes.

9. A computer program product according to claim 1 wherein the computer-readable program code executes on a telephone of the receiving party, on a computer of the receiving party and/or on a network.

10. An apparatus for facilitating a telephone call comprising hardware that is loaded with the computer-readable program code of claim 1.

11. A method for facilitating a telephone call, the method comprising:
delaying connection of an incoming telephone call to a receiving party in response to receipt of a delay instruction from the receiving party, so as to provide the receiving party additional time to accept the incoming telephone call.

12. A method according to claim 11 wherein the delaying comprises:
delaying transfer of the incoming call to the receiving party's voice mail, in response to receipt of the delay instruction from the receiving party.

13. A method according to claim 11 wherein the delaying comprises:
extending a ring cycle for the incoming telephone call beyond the ring cycle for an incoming telephone call for which the delay instruction is not received.

14. A method according to claim 11 wherein the delaying comprises:
presenting a hold message while the connection of the incoming call is being delayed.

15. A method according to claim 11 wherein the delay instruction comprises activation of a given key on the receiving party's telephone.

16. A method according to claim 11 further comprising:
presenting to the receiving party, previously generated notes related to the incoming telephone call, in response to receipt of the delay instruction from the receiving party.

17. A method according to claim 11 wherein the method executes on a telephone of the receiving party, on a computer of the receiving party and/or on a network.

18. An apparatus for facilitating a telephone call comprising hardware that is configured to execute the method of claim 11.

19. A computer program product for facilitating a real time communications session, the computer program product comprising a computer usable storage medium having computer-readable program code embodied in the medium, the computer-readable program code comprising:
computer-readable program code that is configured to delay connection of an incoming real time communication to a receiving party in response to receipt of a delay instruction from the receiving party, so as to provide the receiving party additional time to accept the incoming real time communication.

20. A computer program product according to claim 19 wherein the real time communications session comprises a text message and/or instant message session.
